(19) United States
(12) Patent Application Publication
(10) Pub. No.: US 2023/0327366 A1
(43) Pub. Date: Oct. 12, 2023

(54) ELECTRICAL CONNECTOR

(71) Applicant: Advanced Connectek Inc., New Taipei City (TW)

(72) Inventors: Yubin Li, New Taipei City (TW); Yao Mei Wang, New Taipei City (TW); Shu-Fen Wang, New Taipei City (TW)

(73) Assignee: Advanced Connectek Inc., New Taipei City (TW)

(21) Appl. No.: 18/296,380

(22) Filed: Apr. 6, 2023

(30) Foreign Application Priority Data
Apr. 11, 2022 (CN) 202210371940.6

(51) Int. Cl. H01R 13/52; H01R 13/405

(52) U.S. Cl. CPC H01R 13/5202; H01R 13/5216; H01R 13/405

(57) ABSTRACT

Provided is an electrical connector including an insulator, a plurality of terminals disposed in the insulator, a first housing surrounding the insulator and the terminals, a waterproof sealant, and a second housing disposed on the first housing. The first housing has a connecting port and a flange. The connecting port is configured to connect to another electrical connector, and the flange is disposed along the connecting port. The waterproof sealant is disposed onto the first housing along the connecting port and abutting the flange. The waterproof sealant is kept at a distance from the second housing.

### CROSS-REFERENCE TO RELATED APPLICATION

This application claims the priority benefit of China application serial no. 202210371940.6, filed on Apr. 11, 2022. The entirety of the above-mentioned patent application is hereby incorporated by reference herein and made a part of this specification.

### BACKGROUND

### Technical Field

The present disclosure relates to an electrical connector.

### Description of Related Art

As information technology continues to advance, additional functions may be expanded through external electronic devices with various functions to improve the performance of a computer or digital electronic products. Electrical connectors are usually provided on computers or electronic products to form connection with external electronic devices.

As a standard input/output connecting port, the Universal Serial Bus (USB) connecting port has been widely used in many electronic products to realize the mutual transmission of signals. Products with different product environments have different performance requirements for electrical connectors. For example, they might need to be waterproof and dustproof. In addition, as it is the trend to miniaturize electrical connectors, their structural strength and stability are also given high quality standards.

### SUMMARY

The disclosure provides an electrical connector that forms a sealing structure for the electrical connector with a flange of the housing and waterproof sealant.

The electrical connector according to the disclosure includes an insulator, a plurality of terminals, a first housing, a waterproof sealant, and a second housing. The terminals are disposed in the insulator. The first housing surrounds the insulator and the terminals. The first housing has a connecting port and a flange. The connecting port is configured to connect to another electrical connector, and the flange is disposed along the connecting port. The waterproof sealant is disposed onto the first housing along the connecting port and abuts the flange. The second housing is disposed on the first housing, and the waterproof sealant is kept at a distance from the second housing.

In an embodiment of the disclosure, the first housing is an integrated metal draw-out housing, and the flange extends outward from the annular structure of the first housing by facing away from the connecting port.

In an embodiment of the disclosure, the waterproof sealant is a liquid silicone rubber injection molding (LIM).

In an embodiment of the disclosure, the second housing covers part of the first housing and part of the insulator.

In an embodiment of the disclosure, the second housing is a stamped and bent metal housing welded to the first housing.

In an embodiment of the disclosure, the waterproof sealant has a convex portion protruding from the flange and away from the connecting port.

In an embodiment of the disclosure, the connecting port is configured to connect to another electrical connector along a docking axis, and the flange blocks the waterproof sealant in the docking axis.

In an embodiment of the disclosure, the insulator includes a base and a tongue, the tongue extends from the base, forms a stepped structure, and penetrates the first housing, and the base has another stepped structure facing away from the tongue.

In an embodiment of the disclosure, part of the second housing covers the first housing, and another part of the second housing covers the insulator and is suitable for the other stepped structure.

Based on the above, the first housing of the electrical connector is formed with a flange at the connecting port during manufacture, and the waterproof sealant is disposed along the flange and is kept at a distance from the second housing. In this way, the flange is adapted as a structure for carrying and blocking the waterproof sealant, which not only simplifies the manufacturing process but also further strengthens the bonding and structural strength between the waterproof sealant and the first housing.

### BRIEF DESCRIPTION OF THE DRAWING

FIG. 1 is a schematic diagram of an electrical connector according to an embodiment of the disclosure.

FIG. 2 is a schematic diagram of the electrical connector of FIG. 1 from another perspective.

FIG. 3 is an exploded schematic view of the electrical connector of FIG. 1.

FIG. 4 is a top view of the electrical connector of FIG. 1.

FIG. 5 is a cross-sectional view of the electrical connector of FIG. 4.

### DESCRIPTION OF THE EMBODIMENTS

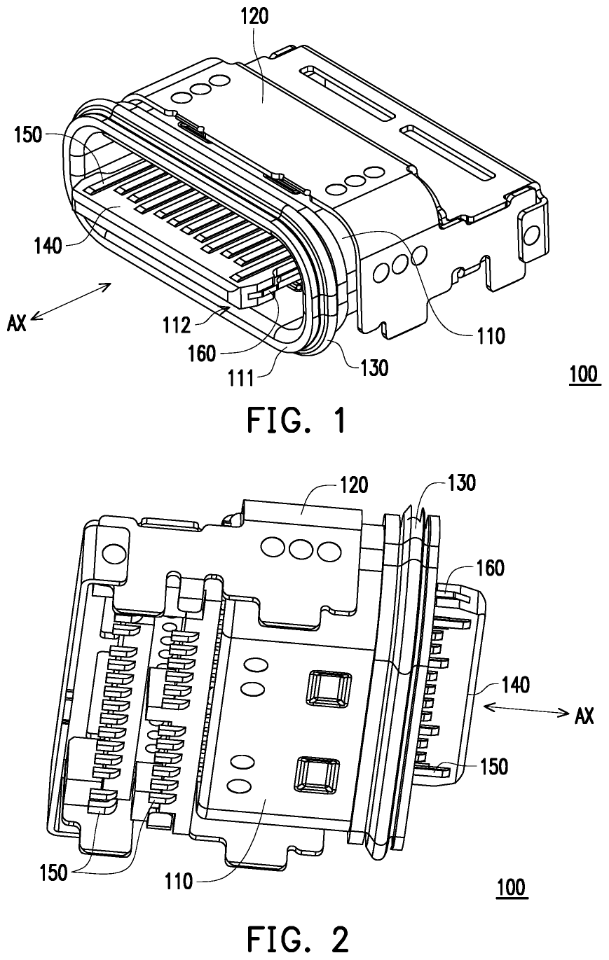

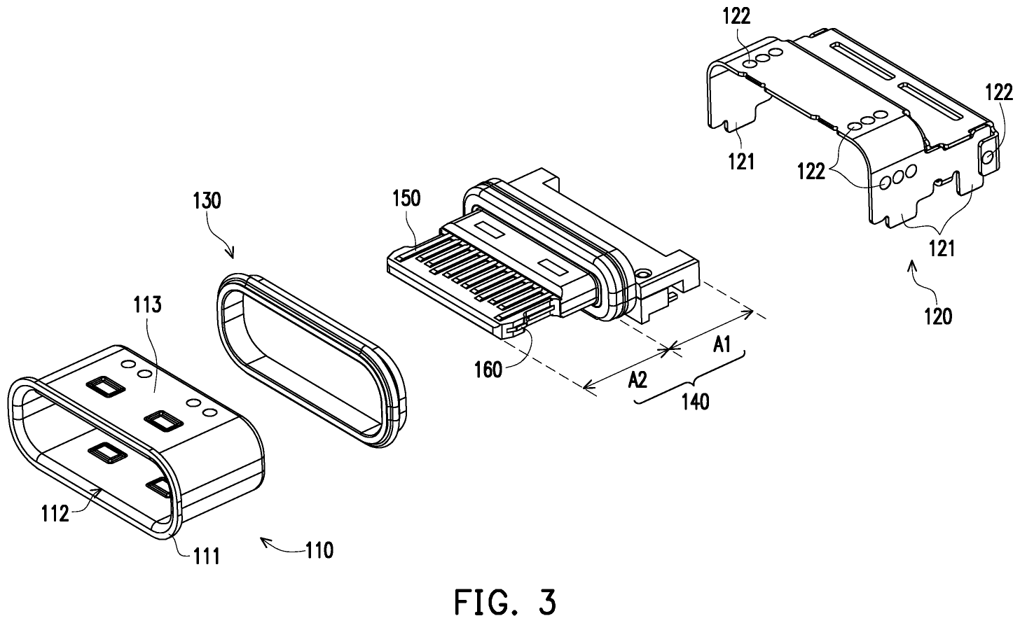

FIG. 1 is a schematic diagram of an electrical connector according to an embodiment of the disclosure. FIG. 2 is a schematic diagram of the electrical connector of FIG. 1 from another perspective. FIG. 3 is an exploded schematic view of the electrical connector of FIG. 1. As shown in FIG. 1 to FIG. 3, in this embodiment, the electrical connector 100 includes an insulator 140, a plurality of terminals 150, a first housing 110, and a waterproof sealant 130. The terminals 150 are disposed in the insulator 140. The first housing 110 surrounds the insulator 140 and the terminals 150. The first housing 110 has a connecting port 112 and a flange 111. The connecting port 112 is configured to connect to another electrical connector (not shown), and the flange 111 is disposed along the connecting port 112. The waterproof sealant 130 is disposed onto the first housing 110 along the connecting port 112 and abuts the flange 111.

Here, the waterproof sealant 130 is a liquid silicone rubber injection molding (LIM). After the first housing 110 is fabricated, the waterproof sealant 130 may be formed on the outer wall surface of the first housing 110 with a liquid silicone molding process, and then the rest of the components may be assembled in sequence. More specifically, the first housing 110 of this embodiment is an integral metal draw-out housing, and the flange 111 extends outwardly from the annular structure 113 of the first housing 110 by facing away from the connecting port 112. In other words, the flange 111 is formed along a circumference of the front end portion of the first housing 110. In this way, when the waterproof sealant 130 is fabricated on the first housing 110, a closed space may be formed as the mold is matched with the flange 111, which facilitates the injection of the liquid silicone into the closed space. Here, because the flange 111 extends outward from the connecting port 112, the injected liquid silicone is prevented effectively from overflowing into the first housing 110 through the connecting port 112 during the molding process of the waterproof sealant 130.

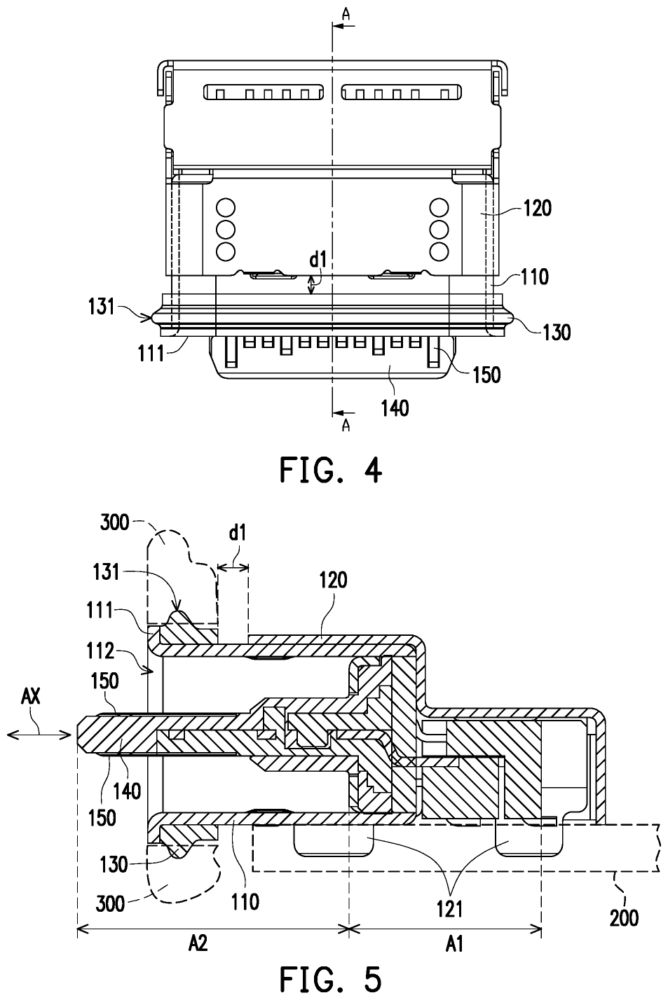

FIG. 4 is a top view of the electrical connector of FIG. 1. FIG. 5 is a cross-sectional view of the electrical connector of FIG. 4, which is a cross-sectional structure formed along the section line A-A in FIG. 4. Please refer to FIG. 3 to FIG. 5 at the same time. In this embodiment, the waterproof sealant 130 has a convex portion 131 protruding from the flange 111 and away from the connecting port 112. As described in the previous paragraph, the connecting port 112 of the first housing 110 may be connected to another electrical connector along a docking axis AX as shown in FIG. 4 and FIG. 5, and thus the flange 111 needs to block the sealant 130 in the docking axis AX and prevent the liquid silicone from flowing into the connecting port 112.

Furthermore, as shown in FIG. 5, the electrical connector 100 of this embodiment is, for example, a receptacle electrical connector disposed in an electronic device 300, and the aforementioned waterproof sealant 130 has a convex portion 131 protruding beyond the flange 111 to abut the electronic device 300. As shown in FIG. 5, the interference between the protruding portion 131 and the electronic device 300 occurs. In other words, the electronic device 300 presses and deforms the waterproof sealant 130 to achieve the interference fit accordingly, as a way to achieve the sealing effect.

As shown in FIG. 1 to FIG. 3, the electrical connector 100 of this embodiment further includes a second housing 120 disposed on the first housing 110. The second case 120 covers part of the first case 110 and part of the insulator 140 simultaneously. Different from the manufacturing process of the first housing 110, the second housing 120 in this embodiment is a stamped and bent metal housing welded to the first housing 110. As shown in FIG. 3, the second housing 120 has a plurality of welding points 122, which are mainly configured for the combination with the first housing 110 in addition to the local welding of its own structure, so that binding strength between the first housing 110 and the second housing 120 may be strengthened.

Again in FIG. 4 and FIG. 5, in this embodiment, the insulator 140 includes a base A1 and a tongue A2. The tongue A2 extends from the base A1, forms a stepped structure, and penetrates the first housing 110. The base A1 has another stepped structure facing away from the tongue A2. Furthermore, the aforementioned second housing 120 covering part of the insulator 140 is consistent with and suitable for the other stepped structure just mentioned. In other words, as shown in FIG. 5, the tongue A2 is a stepped structure that gradually descends from right to left relative to the base A1, and the structure of the base A1 on its right side is a stepped structure gradually descending from left to right. Therefore, the second housing 120 covering the insulator 140 naturally conforms to the structural feature of the stepped structure that descends from left to right.

Again, in FIG. 3, the electrical connector 100 of this embodiment further includes a metallic sheet 160, which is combined with the terminals 150 in the insulator 140 by insert molding. The metallic sheet 160 is also a shielding sheet. The metallic sheet 160 further divides the terminals 150 into two groups, and the arrangement order of the pin assignment of the two groups of the terminals 150 are opposite to each other. Take FIG. 3 as an example: if the pin assignments of the terminals 150 located above the metallic sheet 160 are pin1, pin2, . . . , pin11, and pin12 from right to left, then the pin assignments of the terminals 150 located under the metallic sheet 160 (as the view is shielded from the viewing angle of FIG. 3, please refer to FIG. 2 for further reference) should be pin12, pin11, . . . , pin2, pin1 from right to left. That is to say, the other electrical connector may be inserted in the forward direction or the reverse direction to connect to the electrical connector 100 smoothly.

In addition, there is a distance d1 between the waterproof sealant 130 and the second housing 120 along the docking axis AX in this embodiment. In other words, the second housing 120 stacked on the first housing 110 and the waterproof sealant 130 disposed onto the first housing 110 are not in contact with each other. This is to avoid interference with the waterproof sealant 130 when the second housing 120 is assembled to the first housing 110, which is unfavorable for the bonding processes such as welding of the first housing 110 and the second housing 120. In other words, during the preliminary design of the electrical connector 100, the distance d1 needs to be reserved on the first housing 110 for the predetermined position of the waterproof sealant 130 and the second housing 120 to avoid the structural instability caused by the structural overlap between the second housing 120 and the waterproof sealant 130.

Also, as shown in FIG. 5, the electrical connector 100 of this embodiment is suitable to be disposed on a circuit board 200 and is inserted and soldered to the circuit board 200 particularly only by the pins 121 of the second housing 120, and the first housing 110 is configured to accommodate and carry the insulator 140 and the terminals 150.

To sum up, in the embodiment of the disclosure, the first housing of the electrical connector is formed with a flange at the connecting port during manufacture, and the waterproof sealant is disposed along the flange, so that the flange is adapted as a structure to carry and block the waterproof sealant.

Furthermore, the electrical connector is further combined with a second housing and stacked on the first housing, and the second housing partially covers the first housing and the insulator, allowing the electrical connector to be inserted through the pins of the second housing and electrically connected to the circuit board, in which a distance is kept between the second housing and the waterproof sealant to avoid the instability of the combined structure caused by the overlap between the two structures.

Accordingly, in addition to simplifying the manufacturing process, the electrical connector of the disclosure is able to further strengthen the bonding and structural strength between the waterproof sealant and the first housing.

What is claimed is:

1. An electrical connector, comprising:
an insulator;
a plurality of terminals disposed in the insulator;
a first housing surrounding the insulator and the terminals, wherein the first housing has a connecting port and a flange, the connecting port is configured to connect to another electrical connector, and the flange is disposed along the connecting port;
a waterproof sealant disposed onto the first housing along the connecting port and abutting the flange; and
a second housing disposed on the first housing, wherein the waterproof sealant is kept at a distance from the second housing.

2. The electrical connector according to claim 1, wherein the first housing is an integral metal draw-out housing, and the flange extends outward from an annular structure of the first housing by facing away from the connecting port.

3. The electrical connector according to claim 1, wherein the waterproof sealant is a liquid silicone rubber injection molding.

4. The electrical connector according to claim 1, wherein the second housing covers part of the first housing and part of the insulator.

5. The electrical connector according to claim 1, wherein the second housing is a stamped and bent metal housing welded to the first housing.

6. The electrical connector according to claim 1, wherein the waterproof sealant has a convex portion protruding from the flange and away from the connecting port.

7. The electrical connector according to claim 1, wherein the connecting port is configured to connect to another electrical connector along a docking axis, and the flange blocks the waterproof sealant in the docking axis.

8. The electrical connector according to claim 1, wherein the insulator comprises a base and a tongue, the tongue extends from the base, forms a stepped structure, and penetrates the first housing, and the base has another stepped structure facing away from the tongue.

9. The electrical connector according to claim 8, wherein part of the second housing covers the first housing, and another part of the second housing covers the insulator and is suitable for the another stepped structure.
